(19) United States
(12) Patent Application Publication
(10) Pub. No.: US 2008/0082221 A1
(43) Pub. Date: Apr. 3, 2008

(54) System for monitoring, controlling, and reporting vehicle operation through onboard diagnostic port

(76) Inventor: David Nagy, San Jose, CA (US)

Correspondence Address: Bao Tran;Tran & Associates, 6768 Meadow Vista Court, San Jose, CA, 95135, US

(21) Appl. No.: 11/486,469

(22) Filed: Jul. 14, 2006

(51) Int. Cl. G05D 1/00; G05D 3/00

(52) U.S. Cl. 701/2

(57) ABSTRACT

Systems and methods are disclosed to extract, monitor, analyze, and send data from a vehicle interface module (VIM) coupled to one or more vehicular electronic devices; transmitting vehicle and geographic location data to a handheld device and forwarding the data to a web server over a wide area network; and publishing the data for viewing by end users or for programmatic access by software applications.

### BACKGROUND

The present invention relates to remote vehicle diagnosis and assistance.

Trucks and automobiles have become increasingly more complex with the advent of engine control systems. These engine control systems can exhibit the ability to diagnose, record, monitor, control, and or optimize engine performance. In addition, some engine control systems may offer additional functionality in the form of vehicle security alarms, door locking, ignition enabling, radio control, or other vehicle command and control functionality. Even with the advances in engine control systems it can still be difficult for anyone but a mechanic with special diagnostic equipment to obtain and view the engine performance data and or other engine control system settings. In addition, such engine control system data may only be accessible from a repair or service center location and can not typically be monitored, viewed, or altered while the vehicle is in motion or in operation on the open roadway.

The inability to access and analyze engine performance data while a vehicle is in motion or in operation on an open roadway can prevent accurate engine performance analysis and/or part failure prediction. Accurate part failure prediction can be characterized as the ability to predict part or system degradation or failure based on engine telemetry data and other vehicle operational data before degradation or failure of the part or system occurs. The inability to accurately predict when engine problems may arise can cause the vehicle to become disabled while in between a point of origin and a desired destination. When a vehicle becomes disabled before reaching a desired destination the user of the vehicle and other occupants in the vehicle can be stranded and the user and occupants of the disabled vehicle may not know where or who to call for help, service, or for vehicle repairs. In addition, the inability to diagnose and repair even the simplest of vehicle problems on the side of a roadway can result in travel delays and expense in towing the vehicle to a repair site or service center location where repairs to the vehicle can be effectuated.

In a parallel trend, modern automobiles rely upon computers to control and monitor all aspects of vehicle operation. Today's car contains numerous on-board computers (ECU's) responsible for many systems such as the engine management, transmission, and anti-lock brakes. The ECU relies upon a variety of sensors to monitor vehicle operation such as speed, engine RPM, coolant temperature, and oxygen sensors. While driving, if the vehicle's on-board computer system detects a problem the computer reports the error using a Diagnostic Trouble Code. A Diagnostic Trouble Code number indicates the problem with the vehicle. One scanner known as Car-Pal™ OBD Interface Unit available from Vital Engineering Ltd. can read and clear codes and display live data from the EOBD diagnostics system. This covers engine, power train and emissions faults. If the vehicle ECU has detected a problem, the driver is informed using the “Check Engine” light on the vehicle's dashboard. This light is also known as the Malfunction Indicator Light (MIL). When this light illuminates, a Diagnostic Trouble Code is saved into the ECU memory ready for the Car-Pal OBD Interface Unit to send the value to a PC, PDA or Palm device. The Car-Pal OBD Interface Unit The Car-Pal OBD Interface Unit operates with any vehicle equipped with OBD II, using ISO, SAE or CAN protocols. This covers vehicles built for the USA market since 1996 and for the European and Asian markets since 2001. The Car-Pal OBD Interface Unit can retrieve and clear both Generic and Manufacturer specific diagnostic trouble codes (DTC); display generic code definitions on-screen; switch off ‘Check Engine’ Light; reset the ECU to clear fault codes; display live sensor data and freeze frame data (PC platform only); measure performance data, such as 0-60 mph times and ¼ mile times; communicate with Engine Management System and Emissions Systems; and record “freeze frame” data.

U.S. Pat. No. 6,832,141 describes an onboard diagnostic memory module is configured to plug into the OBD II port and has a real-time clock and power supply, a microprocessor powered from a standard OBD II port, microprocessor operating firmware, and an attached memory. In operation, the onboard diagnostic memory module is preprogrammed with data collection parameters through microprocessor firmware by connection to a PC having programming software for the module firmware. Thereafter, the onboard diagnostic memory module is moved into pin connection with the OBD II port of a vehicle. Data is recorded on a “trip” basis, preferably using starting of the engine to define the beginning of the trip and stopping of the engine to define the end of the trip. Intelligent interrogation occurs by interpretive software from an interrogating PC to retrieve a trip-based and organized data set including hard and extreme acceleration and deceleration, velocity (in discrete bands), distance traveled, as well as the required SAE-mandated operating parameters.

U.S. Pat. No. 6,529,808 describes an On-Board Diagnostics/Inspection Maintenance (OBD/IM) Vehicle Analysis System (OVAS) includes the hardware and software necessary to access the onboard computer systems on 1996 and newer vehicles, determine On-Board Diagnostics Generation II (OBDII) readiness, and recover stored fault codes using the Society of Automotive Engineers (SAE) standardized link. The analyzer is designed to guide the inspector through the OBDII inspection sequence for a particular vehicle and record the results. Information regarding OBDII scanning anomalies (such as “not ready” status of 1996 Subarus) is maintained in the OBD Vehicle Lookup Table (VLT). In addition, information regarding the Data Link Collector (DLC) location is maintained for 1996 and newer vehicles in the OBD-VLT. This information is downloaded to the OVAS analyzers upon initialization and when the OBD-VLT is updated, and is automatically displayed when vehicles undergoing testing match the vehicle criteria (such as make, model, and model year).

U.S. Pat. No. 6,389,337 describes an in-vehicle device data communicates with Internet based data processing resources for the purpose of transacting e-mail, e-commerce, and e-business. The in-vehicle device and the Internet based data processing resources can effectuate a wide variety of e-mail, e-commerce, and e-business including accessing auto part databases, warranty, customer, and other remote databases. In addition, e-mail, e-commerce, and e-business transactions can include vehicle security and vehicle service management, data communicating Internet based radio, audio, MP3, MPEG, video, and other types of data. Furthermore, e-mail, e-commerce, and e-business transactions can include interactive advertising, promotional offers, coupons, and supporting other remote data communications. The in-vehicle device can also include functionality for remote monitoring of vehicle performance, data communicating and accessing remote Internet based content and data, and effectuating adjustments and control of vehicle operation. Remote monitoring and control of vehicle operation can be by way of an Internet based data processing resource and can include engine control system programming and setting adjustment, vehicle monitoring, and transmission of vehicle telemetry and metric data. Vehicle telemetry and metric data can include global positioning system (GPS) data, vehicle operational data, engine performance data, and other vehicle data. The in-vehicle device can also wirelessly data communicate with a communication interface device (COM device) or an Internet appliance. Such COM devices or Internet appliances can data communicate wirelessly with an in-vehicle device and simultaneously data communicate in a wired or wireless mode of operation to Internet based data processing resources, and to other data processing resources.

### SUMMARY

In one aspect, systems and methods are disclosed to extract, monitor, analyze, and send data from a vehicle interface module (VIM) coupled to one or more vehicular electronic devices; transmitting vehicle and geographic location data to a handheld device and forwarding the data to a web server over a wide area network; and publishing the data for viewing by end users or for programmatic access by software applications.

In another aspect, a system includes a vehicle interface module (VIM) coupled to one or more vehicular electronic devices and adapted to read a vehicle's internal operational data and send commands to one or more vehicular electronic devices over a local area network, and send and receive the operational data along with location information over a wide area network; a monitoring and control application coupled to the VIM; a handheld device wirelessly coupled to the VIM, the device communicating with the one or more vehicular electronic devices through the VIM; a dynamically configurable software application and an application programming interface (API) coupled to the handheld device; and a web server coupled to the handheld device.

In another aspect, a method to monitor, collect, and send vehicle data from a vehicle interface module (VIM) coupled to one or more vehicular electronic devices includes transmitting vehicle data to a handheld device; analyzing and displaying vehicle data on a handheld device; forwarding vehicle data to a web server over a wide area network; and publishing vehicle data to authorized users and software applications.

In yet another aspect, systems and methods are disclosed to render assistance to a vehicle by collecting vehicle data from a vehicle interface module (VIM) coupled to one or more vehicular electronic devices; transmitting vehicle data to a handheld device; forwarding vehicle data to a web server over a wide area network; and receiving vehicle data at a call center and dispatching assistance based on vehicle data.

In a further aspect, system to render assistance to a vehicle on-the-road includes a vehicle interface module (VIM) coupled to one or more vehicular electronic devices; a handheld device wirelessly coupled to the VIM, the device wirelessly communicating with the one or more vehicular electronic devices through the VIM; a web server coupled to the handheld device; and a call center coupled to the web server to wirelessly retrieve VIM data and to dispatch assistance.

Implementations of the above aspect may include one or more of the following. The VIM can include a plug-in SAE J1962 connector. The VIM can be a microcontroller, memory, and a Bluetooth radio. The VIM can have an expansion slot. A key FOB can be inserted into the expansion slot to remotely open the vehicle door. The VIM provides full access to the vehicle's ECU data and Diagnostic Trouble Codes reported by the vehicle's ECU. The VIM can collect Throttle position, Engine RPM, Vehicle speed, Calculated load value, Ignition timing advance, Intake air flow rate, Short term fuel trim, Long term fuel trim, Air temperature, Coolant temperature, Oxygen sensors. A positioning system can be connected to the VIM to provide car position. Alternatively, the positioning system can be provided in the handheld device. The position system can be GPS, GLONASS, or GALILEO systems. A call center can access the server and the call center can receive vehicle data and position data from the VIM. The call center can locate customer identification and customer position data and forwards the data to a local repair facility. The local repair facility dispatches a tow truck. The VIM can also perform vehicle diagnosis while the vehicle is on the road.

Advantages of the system may include one or more of the following. The system enables users to avoid problems of having no, or limited, access to internal systems in most vehicles while on the road, for on-going diagnostic and maintenance purposes as well as emergency road services. The system also provides a rich interface to auxiliary comfort and convenience features such as door lock/unlock, power windows, remote start, engine disablement, and multimedia systems. The solution will make real-time data access and commands available to a range of interested parties including individual and fleet automobile owners, emergency road service providers, tow truck operators, auto dealer, and independent auto servicers. The system also enables the user to read and clear the Diagnostic Trouble Codes as often as necessary without incurring the fees from service centers, mobile services and repair shops which charge to read the Diagnostic Trouble Code from the vehicle's ECU memory. Periodic checking of the Diagnostic Trouble Codes helps detect problems before costly repairs may be needed. Once the vehicle is repaired, the Diagnostic Trouble Code(s) can be erased from the ECU using the OBD Interface Unit and the Check Engine light may be extinguished.

### BRIEF DESCRIPTION OF THE DRAWINGS

FIG. 1 shows an exemplary architecture for a system that remotely access vehicle data and render assistance.

FIG. 2A shows an exemplary vehicle system architecture.

FIG. 2B shows an exemplary VIM.

FIG. 2C shows an exemplary car monitoring client and API.

FIG. 3 shows an exemplary operation of the VIM with a handheld device.

FIG. 4 shows an exemplary process for initializing the system.

FIG. 5 shows an exemplary work flow for dispatching tow trucks to assist vehicles.

FIG. 6 shows an exemplary road service client application running on the handheld device.

FIG. 7 shows an exemplary Web application rendered by the Road Service Web Access.

FIG. 8 shows an exemplary tower portal user interface.

FIG. 9 shows an exemplary handheld client user interface supported by the scheduling/dispatching server.

### DESCRIPTION

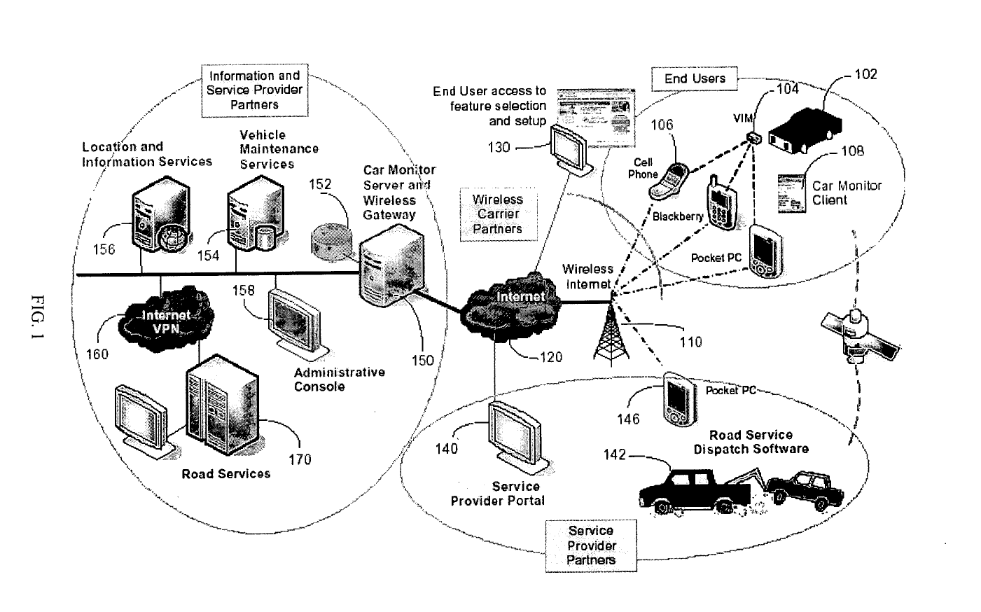

FIG. 1 shows an exemplary architecture for a system that remotely access vehicle data and render assistance. The system includes a plurality of customer sub-systems each including a vehicle 102. In one embodiment, an integrated hardware and software system reads a vehicle 102's internal mechanical operational data and sends commands into the vehicle's sub-systems over a wireless personal area network (WPAN). The system can also send and receive vehicle-related data and receive commands over a wide area wireless network (WWAN).

The system includes a Vehicle Interface Module (VIM) 104. The VIM 104 is installed in the vehicle through a plug-in SAE J1962 connector. The VIM 104 includes a microcontroller and memory, a Bluetooth radio, and an SDIO slot for the addition of an optional Key FOB. The VIM 104 provides full access to the vehicle's ECU data and allows the system to access Diagnostic Trouble Codes reported by the vehicle's ECU. The VIM 104 helps users to service and maintain the vehicle with live sensor display. The VIM 104 also reads and displays reason for Check Engine Light or MIL (Malfunction Indicator Light) which indicates presence of fault codes (DTC, Diagnostic Trouble Codes). The VIM 104 can collect data such as Throttle position, Engine RPM, Vehicle speed, Calculated load value, Ignition timing advance, Intake air flow rate, Short term fuel trim, Long term fuel trim, Air temperature, Coolant temperature, Oxygen sensors. The VIM 104 can also display diagnostics trouble codes (DTC), clear Check Engine lamp, retrieve and clear Generic and Manufacturer specific diagnostic trouble codes (DTC), display live sensor data and freeze frame data, and communicates with Engine Management System and Emissions Systems.

The VIM 104 communicates with a handheld device 106 such as a cell phone or PDA capable of running the J2ME, Windows Mobile, or BREW operating systems. The handheld device 106 is also equipped with Bluetooth and GSM/GPRS, CDMA/1X, or iDEN voice and data communications. Exemplary handheld device 106 can be the Java J2ME cell phones, Nextel i730, i850, i355, i605, Blackberry, Nextel, Verizon Wireless, Cingular, Sprint MS Windows Mobile Smartphone Edition, Nextel, Verizon Wireless, Cingular, Sprint MS Windows Mobile Pocket PC Edition, Nextel, Verizon Wireless, Cingular, Sprint BREW cell phones. The handheld device 106 runs mobile software components 108 such as a Consumer Application (CA). The CA serves as the user interface to vehicle control and configuration functions and OBDII data access on the VIM 104 via Bluetooth. The CA also supports the ability to transmit the data, manually or automatically, and receive commands remotely via standard wide area wireless networks.

The VIM 104 can run an OBDII Application Platform (OAP) written for the VIM 104 that accepts and responds to requests for OBDII data and configuration settings from the consumer application. The OAP implements a range of OBDII protocols for access to vehicle systems such as the engine, transmission, safety, and chassis. The handheld device also supports an API that enables 3rd party developers to access the VIM.

The handheld device 106 communicates with a server over a wide area network (WAN) 120 such as the Internet. Wireless access to the Internet can be provided through cellular towers 110 that access the Internet through the cellular wireless carriers or service providers that own the towers 110. The system provides road service web access 130 as well a road service tower portal 140. The portal 140 sends a tow truck 142 to render assistance to the vehicle 102. The tow truck driver can also be accessed using a handheld device 146 which can be a SmartPhone, for example.

A server 150 accesses the vehicle data over the WAN 120. The server includes a database 152 for looking up vehicle data as well as manufacturer data. The server-side components can include: a Web Service that allows enterprise applications to access data generated by the VIM 104 and handheld device. The server can also provide an OBDII Database that contains the available OBDII generic, proprietary, and “super-proprietary” features by make, model, and year from 1996 to the present in the database 152, among others. The server 150 is also connected to a virtual private network (VPN) 160 to communicate with a scheduling and dispatching computer or server 154. Also connected to the VPN 160 is a web service computer or server 156 that handles account management and personalization information, among others. A console 158 can be used to access the VPN 160.

A call center 160 is connected to the VPN 160. The call center accesses information captured by servers 150, 154 and 156 to present information to call center service agents. Such information is displayed in a screen 172. The agents can also run tower selection software 174 and dealer part software 176 to order parts if needed, for example. In one embodiment, the call center 170 receives a map of the vehicle's location or position, diagnostic report, vehicle ID (VIN), and mileage, among others. Using the information and software tools, the call center agent can confirm the customer information, selects dealers and towers.

In one embodiment, an integrated hardware and software system reads a vehicle's internal mechanical operational data and sends commands into its subsystems over a wireless personal area network (WPAN). The system can also send and receive vehicle-related data and receive commands over a wide area wireless network (WWAN).

The hardware components include:

1. A Handheld Device (HD) such as a cell phone or PDA capable of running the J2ME, Windows Mobile, or BREW operating systems. It must also be equipped with Bluetooth and GSM/GPRS, CDMA/1X, or iDEN voice and data communications.

2. A Vehicle Interface Module (VIM) that incorporates a plug-in SAE J1962 connector, a microcontroller and memory, a Bluetooth radio, and an SDIO slot for options such as a Key FOB radio or GPS receiver.

The mobile software components include:

1. A Car Monitor client written for the KonaWare Mobility Platform to run on a Handheld Device. The Car Monitor serves as the user interface to vehicle control functions and OBDII data access on the VIM via a network connection such as Bluetooth. It also supports the ability to transmit the data, manually or automatically, and receive commands remotely via standard wide area wireless networks.

2. An OBDII Application (OA) written for the VIM microcontroller that accepts and responds to requests for OBDII data and configuration settings from the consumer application. It implements a range of OBDII protocols for access to vehicle systems such as the engine, transmission, safety, and chassis.

3. An API that enables 3rd party developers to access the VIM.

The server-side components include:

1. A Web Service that allows enterprise applications to access data generated by the CarSpy system.

2. An OBDII Database that contains the available OBDII generic, proprietary, and “super-proprietary” features by make, model, and year from 1996 to the present.

The above embodiment provides a solution to the problems of having no, or limited, access to internal systems in most vehicles while on the road, for on-going diagnostic and maintenance purposes as well as emergency road services. The embodiment also provides a rich interface to auxiliary comfort and convenience features such as door lock/unlock, power windows, remote start, engine disablement, and multimedia systems. The system makes real-time data access and commands available to a range of interested parties including individual and fleet automobile owners, emergency road service providers, tow truck operators, auto dealer, and independent auto servicers.

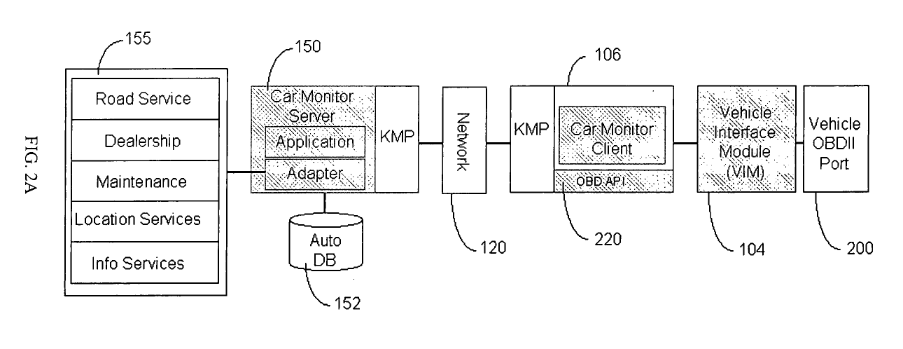

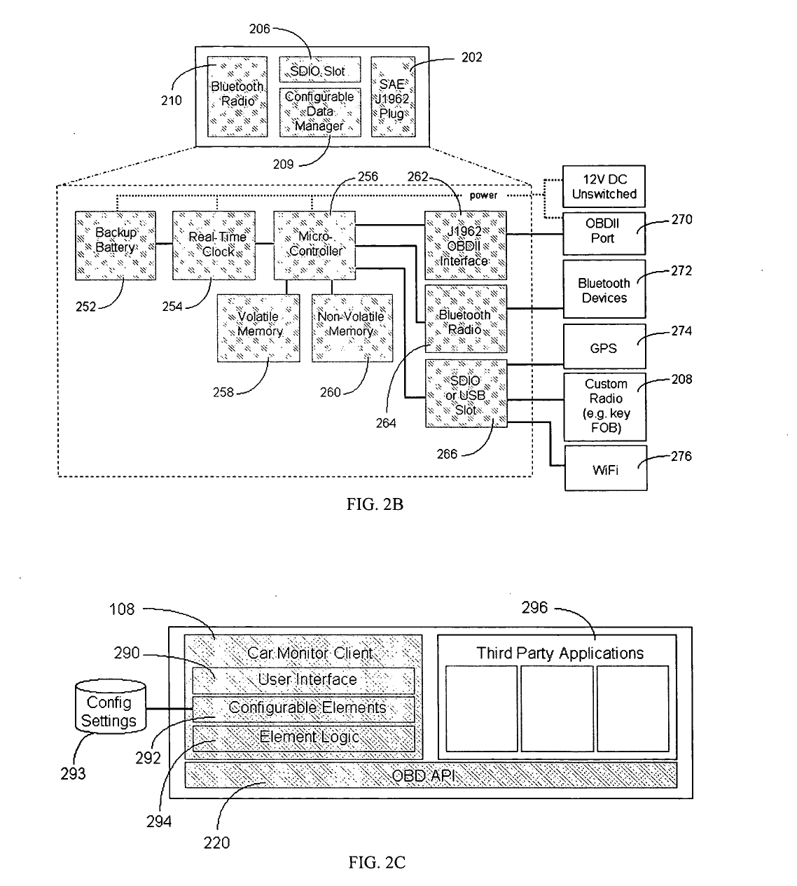

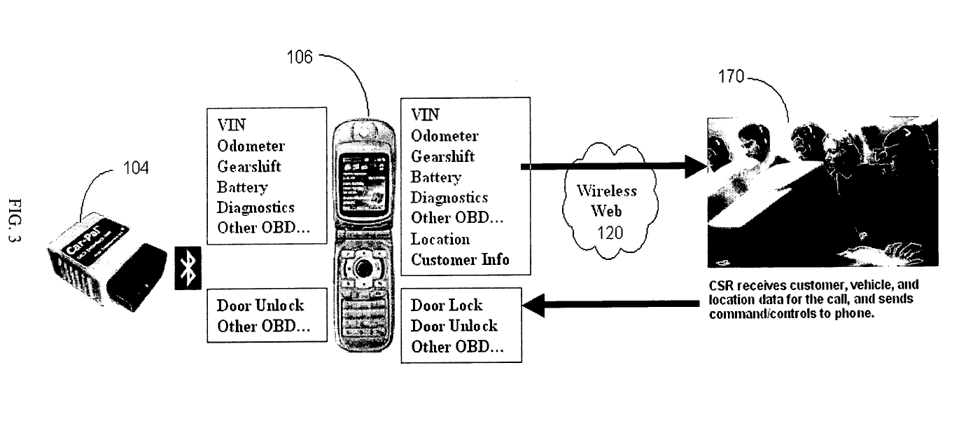

Turning now to FIG. 2A, an exemplary vehicle system architecture is shown. Data from the vehicle 102 can be accessed through a vehicle data bus (OBDII) port 200. A connector 202 such as an SAE J1962 connector is plugged into the port 200 and commands are issued by the VIM 104 to collect vehicle data into a data logger 204. The data logger 204 includes an expansion slot, which can be an SDIO slot 206. A key FOB 208 or other expansion devices can be plugged into the expansion slot 206 to provide additional features and capabilities as desired. Data is transmitted using a radio 210, in this case a Bluetooth radio that is compatible with a radio on the cell phone 220. A car monitoring client software runs on the phone, along with an OBD application programming interface. Data is sent through a KMP over the WAN 120 to a corresponding KMP on the server 150. A corresponding car monitoring application communicates with a database 152. The server 150 can also delegate tasks associated with car monitoring by sending data to a portal 155 CRM/Dispatch portal, a dealer portal, a maintenance portal, or any other external systems.

One embodiment of the VIM is shown in FIG. 2B. As shown therein, an automotive connector 202 such as an SAE J1962 plug is provided. The VIM includes a data manager 209 that communicates with an SDIO slot 206. The data manager also communicates with a Bluetooth radio 210. The VIM also includes a back-up battery 252, a real time clock 254, and a microcontroller 256 that has volatile memory 258 such as RAM and non-volatile memory 260 such as ROM. The microcontroller communicates with a J1962 OBDII interface 262, a Bluetooth radio 264, and an SDIO or USB slot 266. The OBDII interface 262 communicates with an OBDII port 270. The Bluetooth radio 264 communicates with various Bluetooth devices 272 such as cell phones, for example. The SDIO or USB slot 266 can receive various add-on peripherals such as a global positioning system (GPS) 274, a key FOB 208, or a WiFi transceiver 276 or 802.11 transceiver, among others.

The car client and API are shown in more detail in FIG. 2C. As shown therein, the car monitor client 108 includes a user interface 290, configurable elements 292 which are stored in a configuration setting database 293, and element logic 294. The client 108 interacts with one or more third party applications 296 and communicates with an OBD API 220.

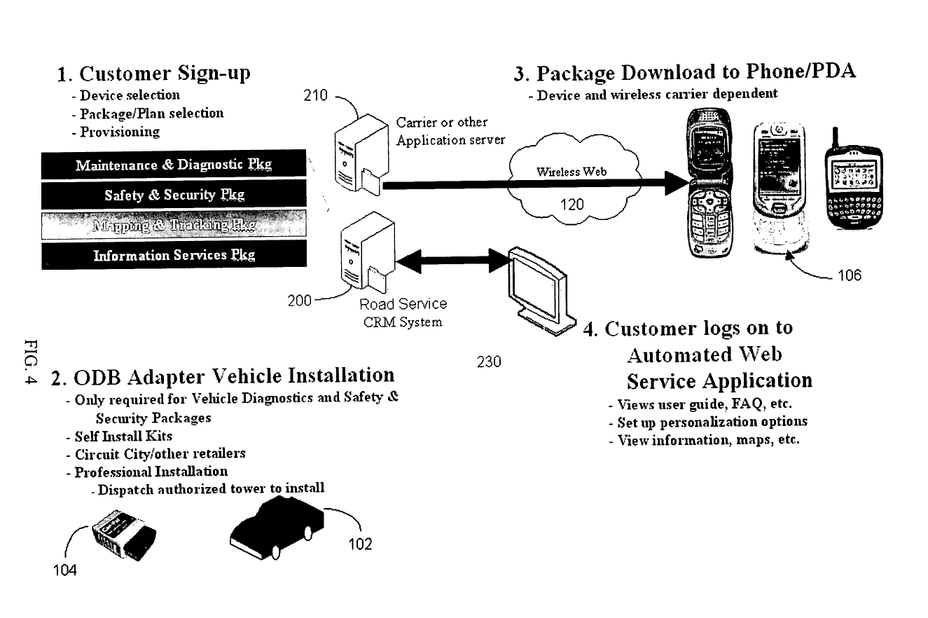

FIG. 3 shows an exemplary operation of the VIM with a handheld device in getting assistance for a vehicle on the road. The user runs a client on the handheld device 106, in this case a cell phone that retrieves information from the vehicle 102. Responding to the query from the cell phone, the VIM 104 transmits data such as VIN, odometer output, gearshift information, battery level, diagnostic information, among others, to the cell phone. The cell phone includes a GPS unit and forwards the information from the VIM 104, along with positional data, over the WAN 120 to a call center 170 where customer service representatives can render assistance until the vehicle is safely in a repair facility. If the key FOB option is available, the cell phone can also issue car door unlock command on request by the user or by the call center over the WAN 120.

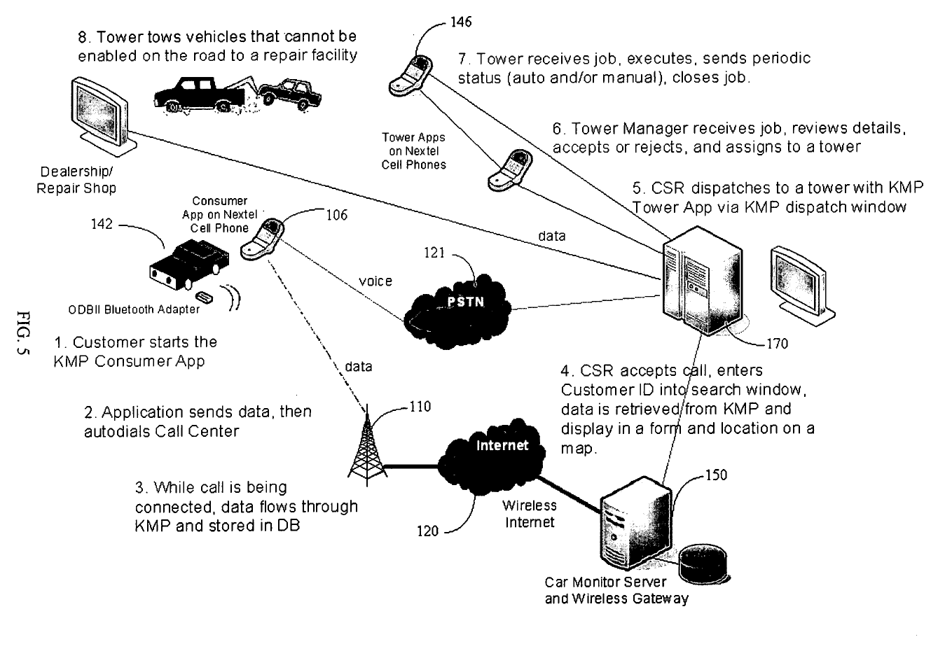

FIG. 4 shows an exemplary process for initializing the system. First, the customer signs up to receive the service (11). In this process, the user selects a particular VIM device as well as a phone. The user also selects a package or a service plan, which can include a maintenance and diagnostic package, a safety and security package, a mapping and tracking package, an information services package, among others. The data provision process is performed. Next, the VIM device 104 is installed in the vehicle 102 (12). The VIM needs to be installed for vehicle diagnostics and safety package as well as the security package. The VIM 104 can be self-installed or a retailer can install the VIM 104 for the user. As another option, an authorized installer can be dispatched to service the customer's vehicle and to install the VIM 104. Next, the handheld device downloads the user's selected package and installs the package as a client running on the handheld device (13). The user then logs on to the Automated Web Service application to setup personalization options and to view user guides, FAQs, or other information (14).

FIG. 5 shows an exemplary work flow for dispatching tow trucks to assist vehicles. In this process, the customer starts the application on the handheld device 106 (1). The application sends the vehicle data, then dials the call center (2). While the voice call is being connected, data flows through the KMP and is stored in database 152 (3). Next, a customer service representative accepts the call and enters the customer ID into a search window and retrieves data for the customer from the KMP and displays the data along with location information on a map (4). The customer service representative dispatches a help request to a tower with the KMP tower application software through a KMP dispatch window (5). The tower receives the job request, executes the request by sending the tow truck 142 to pick up the vehicle 102 (6). Further, the process periodically polls the truck and the VIM for status and closes the job request when the car is in a service center (6).

The system enables users to avoid problems of having no, or limited, access to internal systems in most vehicles while on the road, for on-going diagnostic and maintenance purposes as well as emergency road services. The system also provides a rich interface to auxiliary comfort and convenience features such as door lock/unlock, power windows, remote start, engine disablement, and multimedia systems. The solution will make real-time data access and commands available to a range of interested parties including individual and fleet automobile owners, emergency road service providers, tow truck operators, auto dealer, and independent auto servicers.

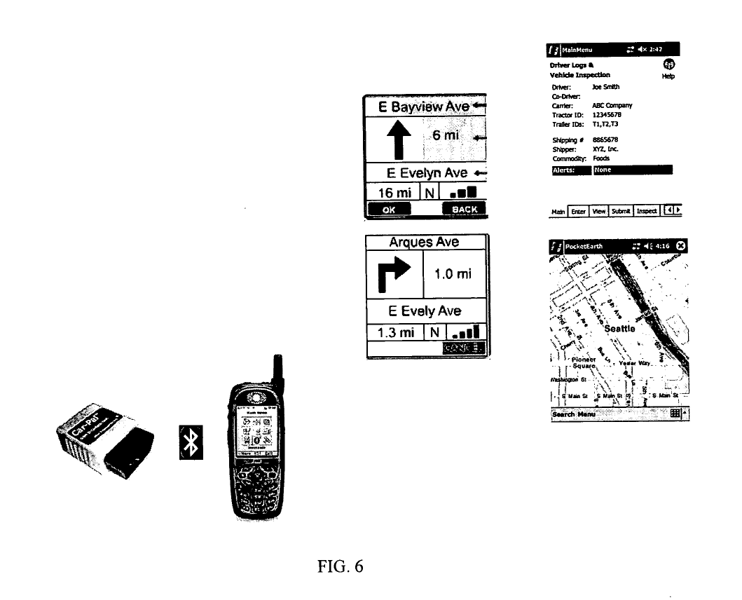

FIG. 6 shows an exemplary road service client application running on the handheld device 106. Modularity allows consumer to choose and download personalized version(s), for example:

Safety & Security Package

Vehicle Diagnostics Package

Information Services Package

LBS Package

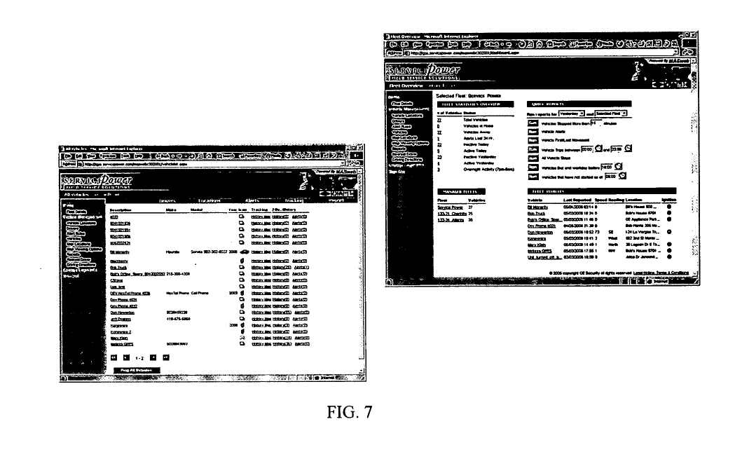

FIG. 7 shows an exemplary Web application rendered by the Road Service Web Access 130 (FIG. 1) that enables consumers to view their information and personalize services. The application provides:

Safety & Security Services

Vehicle Diagnostic Services

Information Services

Location Based Services

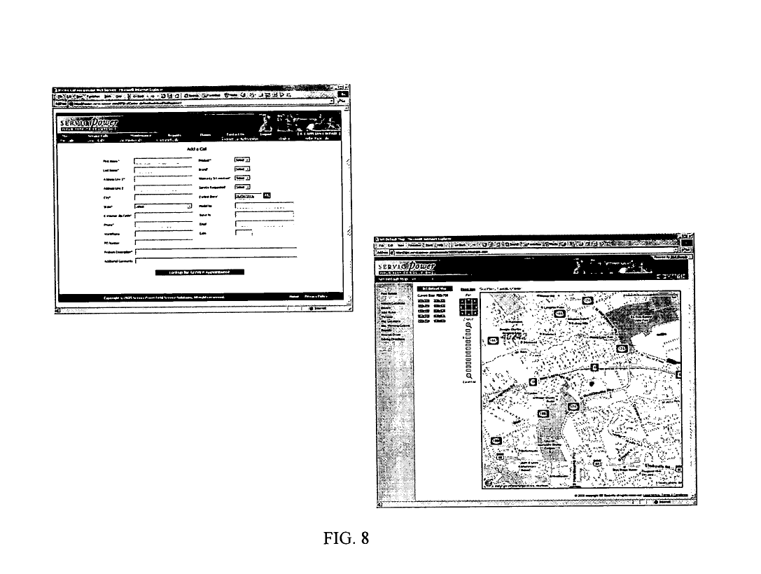

FIG. 8 shows an exemplary tower portal 140 (FIG. 1) user interface. The portal allows tow operator staff to view and accept dispatch jobs received from a CRM; allows tow operator staff to dispatch jobs to tow truck drivers; allows servicer operations to monitor job progress and report status back to the CRM; and provides Feedback to consumer—where is the tow? When will it arrive?

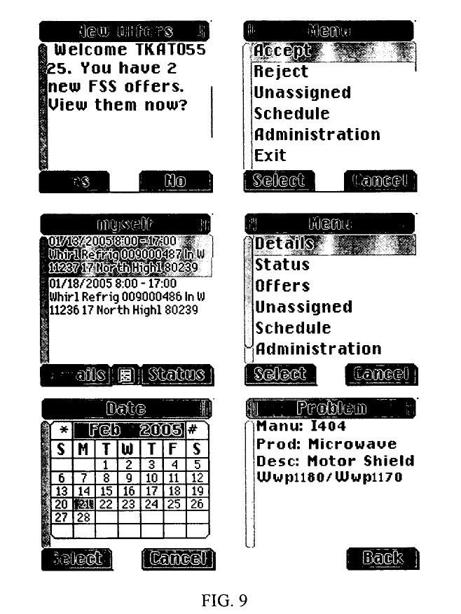

FIG. 9 shows an exemplary handheld client user interface that is supported by the scheduling/dispatching server 154. The handheld device is used by the tow truck drivers and allows tow truck drivers to view jobs and report status back to tow operator operations or CSR.

While this invention has been described with reference to specific embodiments, it is not necessarily limited thereto. Accordingly, the appended claims should be construed to encompass not only those forms and embodiments of the invention specifically described above, but to such other forms and embodiments, as may be devised by those skilled in the art without departing from its true spirit and scope.

What is claimed is:

1. A system, comprising:
a vehicle interface module (VIM) coupled to one or more vehicular electronic devices and adapted to read a vehicle's internal operational data and send commands to one or more vehicular electronic devices over a local area network, and send and receive the operational data along with location information over a wide area network;
a monitoring and control application coupled to the VIM;
a handheld device wirelessly coupled to the VIM, the device communicating with the one or more vehicular electronic devices through the VIM;
a dynamically configurable software application and an application programming interface (API) coupled to the handheld device; and
a web server coupled to the handheld device.

2. The system of claim 1, wherein the VIM comprises a plug-in SAE J1962 connector.

3. The system of claim 1, wherein the VIM comprises a microcontroller, memory, a Bluetooth radio.

4. The system of claim 1, wherein the VIM comprises an expansion slot.

5. The system of claim 4, comprising one of: a key FOB to remotely open the vehicle door, a global positioning system, a WiFi transceiver.

6. The system of claim 1, wherein the VIM provides full access to the vehicle's ECU data and Diagnostic Trouble Codes reported by the vehicle's ECU.

7. The system of claim 1, wherein the VIM collects standard and proprietary data.

8. The system of claim 1, wherein the VIM collects one or more of: Throttle position, Engine RPM, Vehicle speed, Calculated load value, Ignition timing advance, Intake air flow rate, Short term fuel trim, Long term fuel trim, Air temperature, Coolant temperature, and Oxygen sensors.

9. The system of claim 1, comprising a positioning system coupled to one of: the handheld device, the VIM.

10. The system of claim 9, wherein the position system comprises one of: GPS, GLONASS, GALILEO.

11. The system of claim 1, wherein the VIM performs vehicle diagnosis while the vehicle is on the road.

12. A method to monitor, collect, and send vehicle data from a vehicle interface module (VIM) coupled to one or more vehicular electronic devices, comprising:
transmitting vehicle data to a handheld device;
analyzing and displaying vehicle data on a handheld device;
forwarding vehicle data to a web server over a wide area network; and
publishing vehicle data to authorized users and software applications.

13. The method of claim 12, comprising transferring data to the VIM through a plug-in SAE J1962 connector.

14. The method of claim 12, wherein the VIM comprises a microcontroller, memory, a Bluetooth radio.

15. The method of claim 12, wherein the VIM comprises an expansion slot.

16. The method of claim 12, comprising remotely opening the vehicle door using a key FOB.

17. The method of claim 12, comprising providing global positioning data.

18. The method of claim 12, comprising transmitting and receiving data using a WiFi transceiver.

19. The method of claim 12, comprising accessing the vehicle ECU data and Diagnostic Trouble Codes reported by the vehicle ECU.

20. The method of claim 12, wherein the data transmitting comprises conforming to one of: a Bluetooth protocol, a USB protocol.
